(19) United States
(12) Patent Application Publication
(10) Pub. No.: US 2004/0017677 A1
(43) Pub. Date: Jan. 29, 2004

(54) IEEE 1394 or USB powered computer light

(76) Inventor: Mark Howard Krietzman, Palos Verdes Est., CA (US)

Correspondence Address: MARK KRIETZMAN, P.O. BOX 3185, PALOS VERDES, CA, 90274, US

(21) Appl. No.: 10/444,671

(22) Filed: May 23, 2003

Related U.S. Application Data
(63) Continuation-in-part of application No. 09/862,885, filed on May 21, 2001, now Pat. No. 6,575,593.
(60) Provisional application No. 60/206,096, filed on May 20, 2000.

(51) Int. Cl. F21V 33/00

(52) U.S. Cl. 362/85; 362/109; 362/253

(57) ABSTRACT

A computer powered light on a support base with one or more light emitting diodes on one or more flexible necks which is powered via the computers USB or IEEE 1394 port. An auxiliary USB or IEEE 1394 port may be combined to allow for additional devices to be connected to a computer through the computer powered light.

### RELATED APPLICATIONS

This application is a continuation-in-part of U.S. patent application Ser. No. 90/862,885 entitled “IEEE 1394 or USB Powered Computer Light” which claimed the benefit, under Title 35, United States Code 119 (e), of Provisional Patent Applications: No. 60/206,096 entitled “IEEE 1394 or USB Powered Computer Light”, which are hereby incorporated by this reference.

### BACKGROUND OF THE INVENTION

1. Field of the Invention

This present invention relates to a LED lamp for use with desktop, laptop and palmtop computers. More specifically, to a LED illuminator, supported on a base, powered via the USB or the IEEE 1394 port.

2. Related Art

One prior art computer light is taught in U.S. Pat. No. 5,379,201, issued to Friedman, which is essential a flashlight with its own power supply affixed to a computer. Absent from the art is a light or illuminator powered by the USB or IEEE 1394 port of a computer.

### SUMMARY OF INVENTION

The present invention is a light emitting diode (LED) illuminator that plugs into a computer's USB port or the computer's IEEE 1394 port and draws its power there from. The LED is supported on a flexible neck for easy positioning.

One or more LEDs on one or more flexible necks may be powered by the same port. Current drain on the computer can be minimized with current limiting circuitry.

In one embodiment each flexible neck which supports the LED or LEDs is attached to a base which connects to the computer's via the USB port.

In one embodiment each flexible neck which supports the LED or LEDs is attached to a base which connects to the computer's via the IEEE 1394.

The LEDs may be switched. An auxiliary port may also be provided on the base which provides for connection to the computer port which the LED illuminator is plugged into.

Computers have limited numbers of USB ports and/or a Firewire (IEEE 1394) ports. Accordingly in some embodiments the computer light provides one or more auxiliary ports on the base which connect to the computer through the port that the computer powered LED illuminator is plugged into.

The features of the invention believed to be novel are set forth with particularity in the appended claim. The invention itself, however, both as to configuration, and method of operation, and the advantages thereof, may be best understood by reference to the following descriptions taken in conjunction with the accompanying drawings.

### BRIEF DESCRIPTION OF THE DRAWINGS

FIG. 1 is a front perspective view of the preferred embodiment of the computer light.

FIG. 2 is a side view of the preferred embodiment.

FIG. 3A is an component view of the computer light of FIG. 1.

FIG. 3B is an another embodiment with pass-through connectivity, of the computer light.

FIG. 4 is a circuit schematic for the preferred embodiment.

FIG. 5 is an alternate circuit schematic for the computer light.

FIG. 6 is a front perspective view of a preferred embodiment of the computer powered light on base connected to a computer.

FIG. 7 is a partial side view of an alternate embodiment of the computer powered light on base.

FIG. 8 is a partial side view of an alternate embodiment of the computer powered light on base.

FIG. 9 is a partial perspective view of an alternate embodiment of the computer powered light on base.

### PREFERRED EMBODIMENTS OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for claims and as a representative basis for teaching one skilled in the art to variously employ the present invention in virtually any appropriately detailed structure.

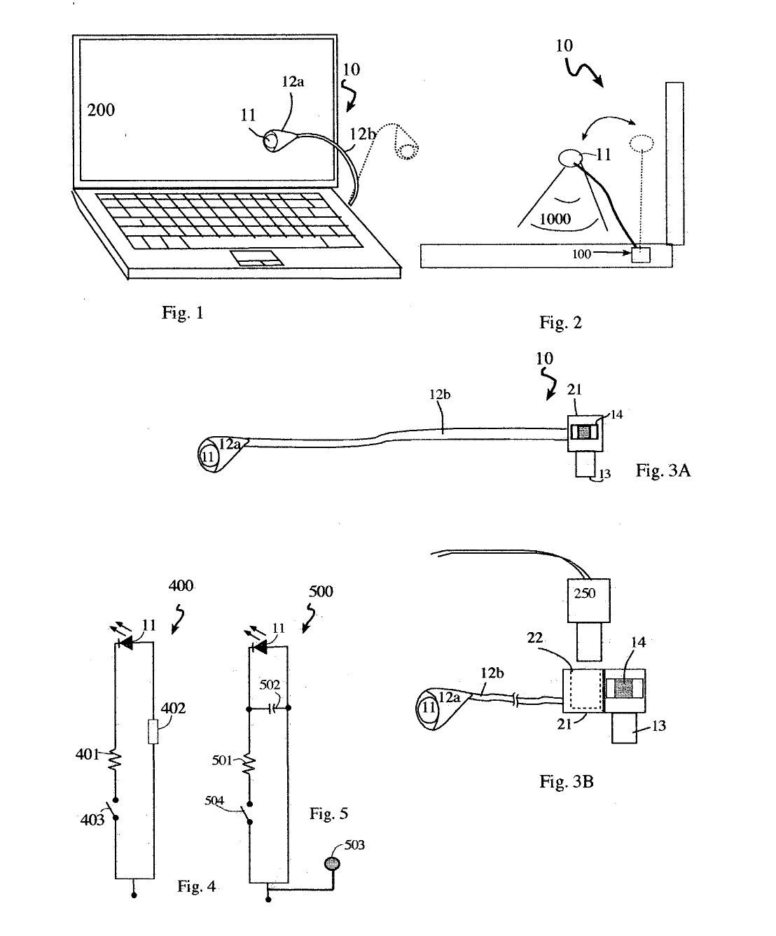

For the preferred embodiment shown in FIGS. 1 & 2, a single light-emitting diode “LED” 11 is affixed to a LED receiving head 12a at the end a flexible neck 12b which in turn is attached to a male jack 13 via two long conductive lead wires (not shown), which mate with either the USB or IEEE 1394 port 100 on a computer 200, to produce an illumination 1000. It is envisioned that dual LEDs on dual flexible necks may be substituted for the single LED without departing from the intended scope of the invention. Light emitting diodes 11 useful for this illuminator include, but are not limited to, those associated with wavelength in a specific spectral region, visible (about 400 nanometers to about 700 nanometers) or non-visible such as red light, blue light, or yellow light, IR, UV and those which produce a wide spectrum (white light) comprising more than one distinct spectral region of light.

In FIGS. 3A & 3B an “on/off” slide switch 14, which allows selective turning “on” and “off” of the LED 11, is shown integrated into the connector body 21 from which extends the male jack 13. In a dual LED dual flexible neck configuration dual switch may be used, or a multi-function single switch controlling the current to both LEDs. In FIG. 3B an auxiliary female USB or IEEE 1394 port 22 is connected to, or formed as part of, the connector body 21 which is able to receive a USB or IEEE 1394 plug 250 from a peripheral component such as a printer, keyboard, mouse, or zip drive.

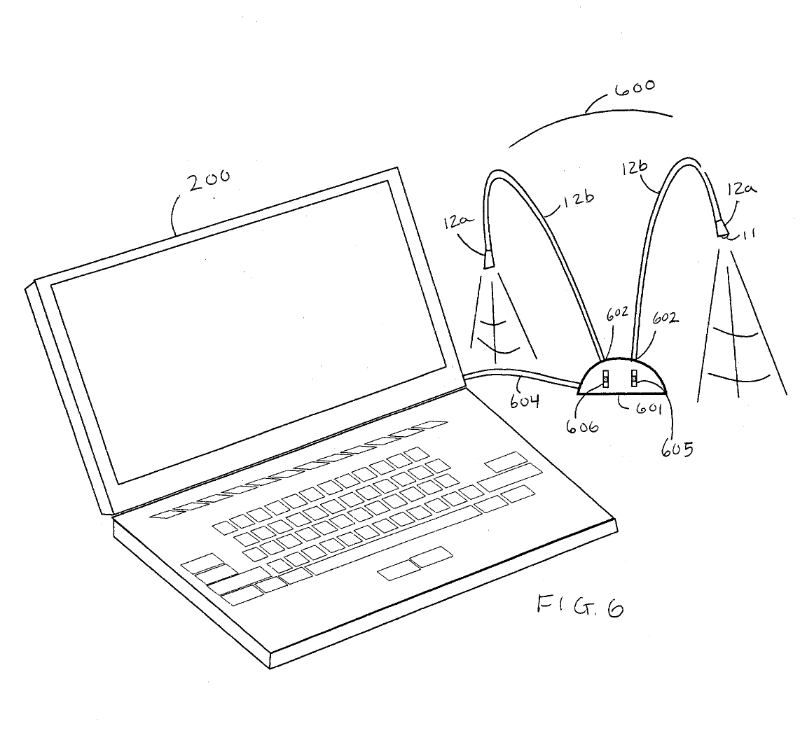

The current to the auxiliary female USB or IEEE 1394 port 22 is non-switched (not interrupted when the “on/off” slide switch 14 on the connector body 21 is switched (FIG. 5)).

Referring now to FIG. 4 there are illustrated a circuit schematic for the preferred embodiment, generally designated 400.

The current to the LED 11 may be limited by placing a resistor 401 in the circuit an additional voltage controlling device may also be added 402. The on/off switch 403 is used to power the LED 11.

Referring now to FIG. 5 there are illustrated an alternate circuit schematic for the computer light, generally designated 500.

The LED 11 is run efficiently by placing a resistor 501 in the circuit, a capacitor 502 may be added to strobe the LED 11 at a rate above the visual threshold. A fully powered USB or IEEE 1394 female port 503 shunts off the computers powered port, and is thereby not effected by the on/off switch 504.

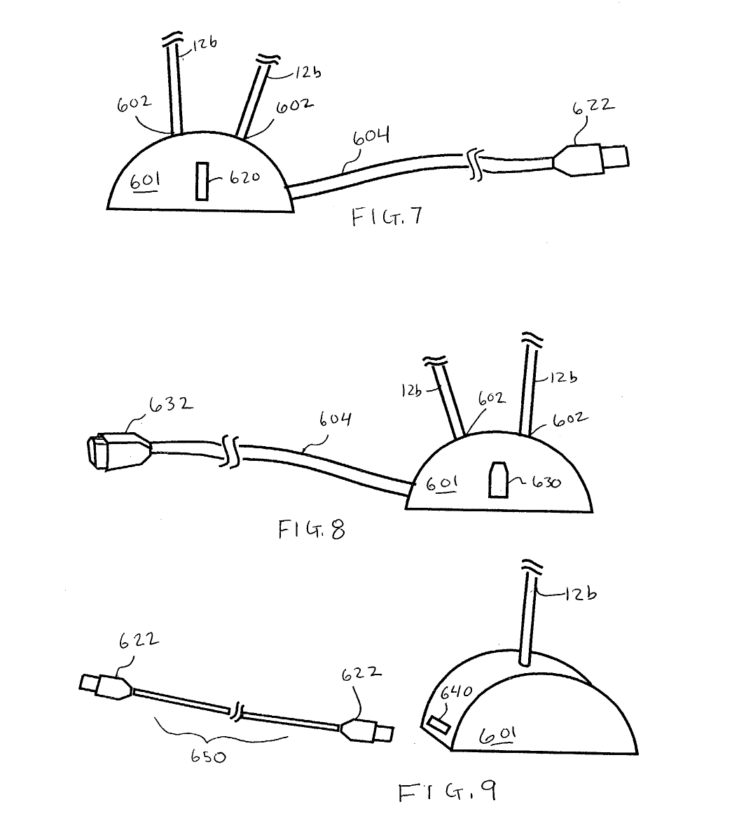

FIG. 6 shows an LED illuminator 600, supported on a base 601. The base should be adequate size and weight to support the two elongated flexible necks 12b attached thereto. The flexible necks 12b attach at a bottom end 602 to the base 601. A single light-emitting diode “LED” so is affixed to a LED receiving head 12a at the other end of each flexible neck 12b. Within the base, not shown, is the connection of the LEDs 11 via conductive lead wires to the cable connect 604. The cable connect 604 extends from the base 601. When the base supported LED illuminator 600 is for a USB port connection, a male USB jack ( shown in FIG. 7) is at the remote end of the cable connect 604. Alternatively, when the base supported LED illuminator 600 is for a IEEE 1394 port connection, a male IEEE 1394 jack (shown in FIG. 8) is at the remote end of the cable connect 604. Each of the LEDs 11 is connected to an on/off switch 600 and 606 whereby the LEDs can be independently switched on or off.

FIG. 7 shows an embodiment which provides an additional non-switched USB port 620 affixed to the base which connects to the computer through the base 601 and cable connect 604 via the male USB jack 622. The illustration of a single non-switched additional port is not a limitation, those skilled in the art will recognize that multiple additional ports may be provided.

FIG. 8 shows an embodiment which provides an additional non-switched IEEE 1394 port 630 affixed to the base which connects to the computer through the base 601 and cable connect 604 via the male IEEE 1394 jack 632. The illustration of a single non-switched additional port is not a limitation, those skilled in the art will recognize that multiple additional ports may be provided.

FIG. 9 shows a base 601 which is connectable to the computer via a connection cable. In this embodiment a USB cable 650 is indicated. One male USB jack connects with a computer, the other male USB jack mates with a female USB port 640 on the base 601. The female USB port is conductively linked to at least one LED (not shown). Those skilled in the art will recognize that the USB jacks and ports may be replaced by IEEE 1394 ports and jacks.

Since certain changes may be made in the above apparatus without departing from the scope of the invention herein involved, it is intended that all matter contained in the above description, as shown in the accompanying drawing, shall be interpreted in an illustrative, and not a limiting sense.

What is claimed is:

1. A computer powered light comprising:
a base;
an elongated flexible support attached to the base;
at least one light emitting diode affixed to the flexible support; and,
a cable connect extending from the base which is conductively linked to each light emitting diodes with a male USB jack at the remote end whereby the computer light can plug into the USB port of a computer to supply electricity to each light emitting diode.

2. The computer powered light of claim 1, further comprising an on/off switch whereby at least on light emitting diode may be switched on or off.

3. The computer powered light of claim 2, wherein the on/off switch affixed to the base.

4. The computer powered light of claim 2, wherein the on/off switch affixed to cable connect.

5. The computer powered light of claim 1, further comprising a non-switched female USB port on the base, whereby at least one additional USB device may be connected to a computer via the at least one non-switched female USB port.

6. The computer powered light of claim 1, further comprising current limiting circuitry of at least one resistor placed in the circuit between the light emitting diode and the male jack.

7. The computer powered light of claim 1, wherein each light-emitting diode emits a pre-determined wavelength of visible spectrum light between about 400—and about 700 nms.

8. The computer powered light of claim 1, wherein each light-emitting diode emits white light.

9. The computer powered light of claim 1, further comprising:
a second elongated flexible support attached to the base; and,
at least one light emitting diode, affixed to the second elongated flexible support, conductively linked to the cable connect.

10. A computer powered light comprising:
a base;
an elongated flexible support attached to the base;
at least one light emitting diode affixed to the flexible support; and,
a USB port affixed to the base which is conductively linked to each light emitting diode, whereby a USB connection cable, to provide power to each light emitting diode, can by plugged in.

11. A computer powered light comprising:
a base;
an elongated flexible support attached to the base;
at least one light emitting diode affixed to the flexible support; and,
a cable connect extending from the base which is conductively linked to each light emitting diodes with a male IEEE 1394 jack at the remote end whereby the computer light can plug into the IEEE 1394 port of a computer to supply electricity to each light emitting diode.

12. The computer powered light of claim 11, further comprising an on/off switch whereby at least on light emitting diode may be switched on or off.

13. The computer powered light of claim 21, wherein the on/off switch affixed to the base.

14. The computer powered light of claim 12, wherein the on/off switch affixed to cable connect.

15. The computer powered light of claim 11, further comprising a non-switched female IEEE 1394 port on the base, whereby at least one additional IEEE 1394 device may be connected to a computer via the at least one non-switched female IEEE 1394 port.

16. The computer powered light of claim 11, further comprising current limiting circuitry of at least one resistor placed in the circuit between the light emitting diode and the male jack.

17. The computer powered light of claim 11, wherein each light-emitting diode emits a pre-determined wavelength of visible spectrum light between about 400—and about 700 nms.

18. The computer powered light of claim 11, wherein each light-emitting diode emits white light.

19. The computer light of claim 11, further comprising:
a second elongated flexible support attached to the base; and,
at least one light emitting diode, affixed to the second elongated flexible support, conductively linked to the cable connect.
